(19) United States
(12) Patent Application Publication
(10) Pub. No.: US 2012/0155651 A1
(43) Pub. Date: Jun. 21, 2012

(54) SOUND FIELD ADJUSTMENT DEVICE

(75) Inventors: Kensaku Obata, Kawasaki (JP); Akihiro Iseki, Kanagawa (JP); Yoshiki Ohta, Kanagawa (JP)

(73) Assignee: PIONEER CORPORATION, Kanagawa (JP)

(21) Appl. No.: 13/380,404

(22) PCT Filed: Jun. 18, 2010
(86) PCT No.: PCT/JP2010/060351

§ 371 Date: Mar. 13, 2012

(30) Foreign Application Priority Data
Jun. 24, 2009 (JP) PCT/JP2009/061503

(51) Int. Cl. H04R 5/00

(52) U.S. Cl. 381/17

(57) ABSTRACT

A sound field adjusting device reproduces signals from plural speaker pairs arranged in an acoustic space. The device supplies signals to the plural speakers, gives different delays for the respective frequency bands to the signals supplied to at least to a proximity speaker pair which is a speaker pair closest to a listening position among the plural speakers, and gives a delay of a constant delay amount regardless of the frequency band to the speaker pairs other than the speaker pair to which the delays of different delay amounts for the respective frequency bands are given. In this case, the sound field adjusting device does not perform level adjustment, and the sound field adjustment is performed by only adjusting the delay amounts. Therefore, deterioration of sound pressure balance at the position other than the listening position can be avoided, and sound pressure balance at the listening position improved.

### TECHNICAL FIELD

The present invention relates to a device for adjusting a sound field.

### BACKGROUND TECHNIQUE

In an audio system having a plurality of speakers and providing a high-quality acoustic space, it is required to automatically create an appropriate acoustic space providing a presence. Namely, since it is quite difficult to appropriately adjust a sound pressure characteristic of a sound reproduced by plural speakers even if a listener manipulates an audio system to create an appropriate acoustic space by himself, it is required that the audio system side automatically adjusts the sound field.

For example, in a vehicle compartment, the arrangement of the speakers viewed from a listener is not a concentric arrangement of speakers SP1 to SP5 around the listener positioned at the center as shown in FIG. 26A, but is an asymmetric arrangement as shown in FIG. 26B. Therefore, the sound pressure balance is deteriorated at the listener position shown in FIG. 26B.

In order to avoid this influence, as shown in FIG. 26C, there is proposed a device for adjusting the sound pressure balance at the driver's seat by controlling the input signals such that the volume of the speaker SP1 near the driver's seat becomes lower than that of the speaker SP4 far from the driver's seat or by applying a time alignment correction by the delay units D1 to D4 (See. Patent references 1 and 2, for example).

### PRIOR ART REFERENCES

### Patent References

Patent Reference 1: Japanese Utility Model Application Laid-open under No. H06-13292

Patent Reference 2: Japanese Patent Application Laid-open under No. 2001-224092

### DISCLOSURE OF INVENTION

### Problem to be Solved by the Invention

However, since the sound field characteristic adjusting device disclosed in Patent reference 1 and the automatic sound field correcting system disclosed in Patent reference 2 adjust the level itself, there is such a problem that the sound pressure balance is further deteriorated at the seat (e.g., the assistant driver's seat) other than the seat subjected to the adjustment.

The above is one example of problems to be solved by the present invention. It is an object of the present invention to provide a sound field adjusting device capable of improving the sound pressure balance at the listening position subjected to the adjustment and diminishing the deterioration of the sound pressure balance at other positions.

### Means for Solving the Problem

The invention described in claim 1 is a sound field adjusting device which is arranged in an acoustic space and which reproduces signals from plural speakers arranged within a predetermined distance from a listening position, including: a signal supplying unit which supplies the signals to the plural speakers; a frequency band dependent delay unit which gives delays of delay amounts different for respective frequency bands to the signals supplied to at least a proximity speaker pair, which is a speaker pair nearest from the listening position; and a constant delay unit which gives delays of a constant delay amount to the speaker pairs, other than the speaker pairs to which the frequency band dependent delay unit gives the delays, regardless of the frequency bands.

### BRIEF DESCRIPTION OF THE DRAWINGS

FIGS. 1A and 1B are diagrams schematically showing a speaker layout of a first embodiment.

FIG. 2 is a block diagram showing a configuration of a sound field adjusting device.

FIGS. 3A and 3B are diagrams showing a method of determining a constant delay amount.

FIGS. 4A and 4B are diagrams showing a method of determining a constant delay amount.

FIGS. 5A to 5C are diagrams showing a method of determining delay amounts for the respective frequency bands.

FIG. 6 is a diagram showing set delay values of the sound field adjusting device according to the first embodiment.

FIGS. 7A to 7C show sound pressure distributions in a case where delay amount is set to be constant regardless of high or low frequency.

FIGS. 8A and 8B show a sound pressure distribution in a case where the delay is set according to the first embodiment.

FIGS. 9A to 9C are diagrams showing a level difference between a front microphone and a rear microphone.

FIGS. 10A to 10C are diagrams showing a level difference between a left microphone and a right microphone.

FIGS. 11A to 11C are diagrams showing a sound pressure level between the speakers at a position of an assistant driver's seat.

FIGS. 12A and 12B are diagrams schematically showing a speaker layout according to a second embodiment.

FIGS. 13A and 13B are diagrams showing a method of determining a constant delay amount.

FIGS. 14A to 14C are diagrams showing a method of determining delay amounts for the respective frequency bands.

FIGS. 15A to 15C are diagrams showing a method of determining delay amounts for the respective frequency bands.

FIG. 16 is a diagram showing set delay values of the sound field adjusting device according to the second embodiment.

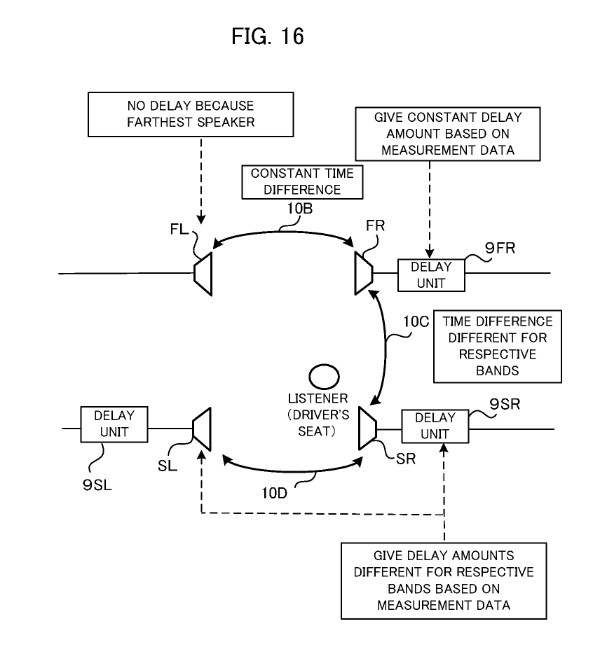

FIG. 17 is a diagram showing delay amounts of the respective speakers according to the second embodiment.

FIGS. 18A to 18C are diagrams showing a level difference between a front microphone and a rear microphone.

FIGS. 19A and 19B are diagrams showing a level difference between a left microphone and a right microphone.

FIGS. 20A to 20C are diagrams showing a sound pressure level between the speakers at a position of an assistant driver's seat.

FIGS. 21A and 21B are diagrams showing a relation between a distance to a proximity speaker pair and an optimum delay amount.

FIGS. 22A and 22B are diagrams showing a relation between a distance to a proximity speaker pair and an optimum delay amount.

FIGS. 23A and 23B are diagrams showing a relation between a distance to a proximity speaker pair and an optimum delay amount.

FIGS. 24A and 24B are diagrams showing a relation between a distance to a proximity speaker pair and an optimum delay amount.

FIG. 25 is a diagram showing a method of determining delay amounts in another embodiment.

FIGS. 26A to 26C are diagrams schematically showing a sound field correction of a conventional method.

### DETAILED DESCRIPTION OF THE PREFERRED EMBODIMENTS

According to one aspect of the present invention, there is provided a sound field adjusting device which is arranged in an acoustic space and which reproduces signals from plural speakers arranged within a predetermined distance from a listening position, including: a signal supplying unit which supplies the signals to the plural speakers; a frequency band dependent delay unit which gives delays of delay amounts different for respective frequency bands to the signals supplied to at least a proximity speaker pair, which is a speaker pair nearest from the listening position; and a constant delay unit which gives delays of a constant delay amount to the speaker pairs, other than the speaker pairs to which the frequency band dependent delay unit gives the delays, regardless of the frequency bands.

The above sound field adjusting device can be applied to a device for adjusting a sound field in a vehicle, for example. The above sound field adjusting device reproduces signals from plural speaker pairs arranged in an acoustic space. The sound field adjusting device supplies signals to the plural speakers, gives delays of different delay amounts for the respective frequency bands to the signals supplied at least to a proximity speaker pair which is a speaker pair closest to a listening position among the plural speakers, and gives a delay of a constant delay amount regardless of the frequency band to the speaker pairs other than the speaker pair to which the delays of different delay amounts for the respective frequency bands are given. In this case, the sound field adjusting device does not perform the level adjustment, and the sound field adjustment is performed by only adjusting the delay amounts. Therefore, it is possible to avoid the deterioration of sound pressure balance at the position other than the listening position, caused by adjusting the sound pressure balance at the listening position, and the sound pressure balance at the listening position can also be improved. The proximity speaker mentioned herein is one of the speaker pairs in the acoustic space, whose distance from the listening position is shortest. The speaker pair is a pair of the speakers.

Generally, if the influence by the head is neglected, the sound pressure balance can be adjusted by giving a constant delay amount regardless of the frequency and positioning the high sound pressure range near the listening position. However, if the head of the listener exists at the listening position, the levels in front and behind the listening position is disturbed due to the influence by the head. It is said that the influence by the head is larger as the frequency is higher and larger as the distance from the listening position is shorter.

Therefore, the sound field adjusting device according to the present invention gives the delay amounts different for the respective frequency bands to the signals supplied to the proximity speaker pair. In this way, since the sound field adjusting device gives the delays of delay amounts different for the respective frequency bands to the speaker pair susceptible to the influence by the head at the listening position, it becomes possible to avoid the deterioration of the sound pressure balance in front and behind the listening position and the position near the listening position.

In one mode of the above sound field adjusting device, the speaker pairs are arranged in one of a front-rear direction and a left-right direction of the listening position, and the frequency band dependent delay unit determines the delay amounts such that a level difference of the proximity speaker pair becomes equal to or smaller than a predetermined value. In this way, since the sound field adjusting device reduces the level difference of the proximity speaker pair susceptible to the influence by the head at the listening position, it is possible to avoid the sound pressure level difference in front and behind the listening position.

In another mode of the above sound field adjusting device, the speaker pairs are arranged in one of a front-rear direction and a left-right direction of the listening position, the frequency band dependent delay unit determines the delay amounts such that a level difference of the proximity speaker pair becomes zero, and the constant delay unit determines the delay amount such that the level difference of the speaker pairs other than the proximity speaker pair becomes zero. In this case, the sound field adjusting device can make the front-rear level difference and the left-right level difference to be almost zero at the listening position or the position near the listening position.

In another mode of the above sound field adjusting device, the frequency band dependent delay unit makes the delay amounts given to the signal of high frequency larger than the delay amounts given to the signal of low frequency. Generally, the deterioration of the sound pressure level balance due to the influence by the head existing at the listening position is remarkable in a frequency higher than a predetermined frequency. Therefore, the sound field adjusting device makes the delay amounts given to the high frequency signals larger than the delay amounts given to the low frequency signals, and thereby prevents the influence by the head of a person at the listening position and prevents the sound pressure level difference from occurring in the acoustic space.

In another mode of the above sound field adjusting device, the frequency band dependent delay unit gradually increases the delay amounts as the frequency increases, for the signal belonging to a predetermined frequency range equal to or higher than a reference frequency. In this case, the sound field adjusting device can determine the delay amounts in accordance with the influence by the head existing at the listening position.

In another mode of the above sound field adjusting device, the frequency band dependent delay unit and the constant delay unit eliminate the speaker pair farthest from the listening position from the speaker pairs subjected to a process of determining the delay amount. When plural speaker are arranged to surround the listening position, it is not structurally possible to give a desired delay amount to one of the plural speaker pairs. Therefore, such a speaker pair is determined to be the speaker pair which undergoes the smallest influence of the sound pressure balance, i.e., the speaker pair farthest from the listening position.

In another mode of the above sound field adjusting device, the proximity speaker pair is one of the speaker pairs whose vertical distance from the listening position is shortest, and the vertical distance indicates a shortest distance from a straight line connecting the two speakers constituting the speaker pair to the listening position. In this way, by specifying the proximity speaker pair undergoing the largest influence by the head existing at the listening position and setting the appropriate delay amounts different for the respective frequencies, the sound pressure balance can be appropriately improved.

Preferably, the predetermined distance is a distance with which an optimum delay amount making the level difference of the speaker pair zero varies dependently upon the frequency. When the speaker pair is moved to be apart from the listening position, the optimum delay amount making the level difference of the speaker pair zero varies dependently upon the frequency up to a certain distance, but becomes constant when the speaker pair is moved farther than the certain distance. The present invention is effective in a speaker arrangement in which the distance between the listening position and one speaker pair is within the above-mentioned predetermined distance.

### Embodiment

Preferred embodiments of the present invention will be described below with reference to the attached drawings.

### 1st Embodiment

[Speaker Layout]

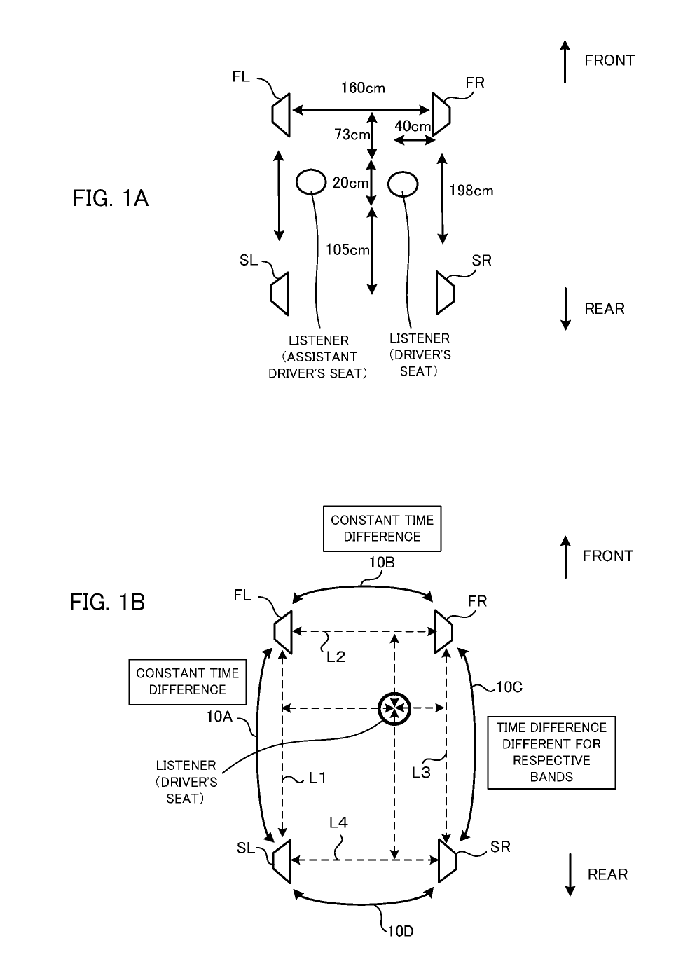

FIG. 1A shows a speaker layout according to a sound field adjusting device of the first embodiment. FIG. 1A schematically shows speakers and listening positions (listeners) in a vehicle compartment. On the front side of the vehicle compartment, a speaker FR is arranged on the right side and a speaker FL is arranged on the left side. On the rear side of the vehicle compartment, a speaker SR is arranged on the right side and a speaker SL is arranged on the left side. The driver's seat is near the right speakers and the assistant driver's seat is near the left speakers. The positional relationship between those four speakers, the driver's seat and the assistant driver's seat is as indicated by the numerical values in FIG. 1A.

The outline of the sound field adjusting device will be described with reference to FIG. 1B. The sound field adjusting device includes delay units (not shown) which add a delay amount to the signal outputted from each of the above speakers. A pair of the speaker SL and the speaker FL is expressed as a speaker pair 10A, and a pair of the speaker FL and the speaker FR is expressed as a speaker pair 10B. A pair of the speaker FR and the speaker SR is expressed as a speaker pair 10C, and a pair of the speaker SL and the speaker SR is expressed as a speaker pair 10D. It is noted that the driver's seat is used as a basis for the sound field adjustment.

In addition, out of the above-mentioned plural pairs of the speakers, the speaker pair for which a vertical distance between the listener position and the straight lines L1 to L4 connecting each speaker pair is shortest is expressed as a proximity speaker pair. The term “vertical distance” indicates a shortest distance from the straight line (including a straight line extended to the outside of the speaker pair) connecting two speakers constituting the speaker pair to the listener position. In this embodiment, the speaker pair 10C is the proximity speaker pair.

The sound field adjusting device in this embodiment gives delays of different delay amounts to the respective frequency bands of the signals supplied to the speaker pair 10C which is the proximity speaker pair, and gives a delay of a constant delay amount to the signals supplied to the speaker pairs other than the proximity speaker pair regardless of the frequency bands. The sound field adjusting device in this embodiment gives a constant delay amount to the signals supplied to the speaker pairs 10A and 10B.

When the plural speakers are arranged to surround the listening position like this embodiment, it is not structurally possible to give a desired delay amount to one of the speaker pairs. In this embodiment, since the speaker pair 10D corresponding to the rear speaker pair in the vehicle compartment gives less influence to the sound pressure balance, the speaker pair 10D is eliminated from the objects of the process of measuring the level difference and determining the delay amounts at the time of determining the delay amounts of the respective speakers. Namely, the above-mentioned one speaker pair to which the desired delay amount cannot be given is set to the speaker pair farthest from the listening position. In this way, the sound field adjusting device appropriately adjust the sound pressure balance by eliminating the rear speaker pair having less influence on the sound pressure balance from the objects of the process for determining the delay amount.

[Sound Field Adjusting Device]

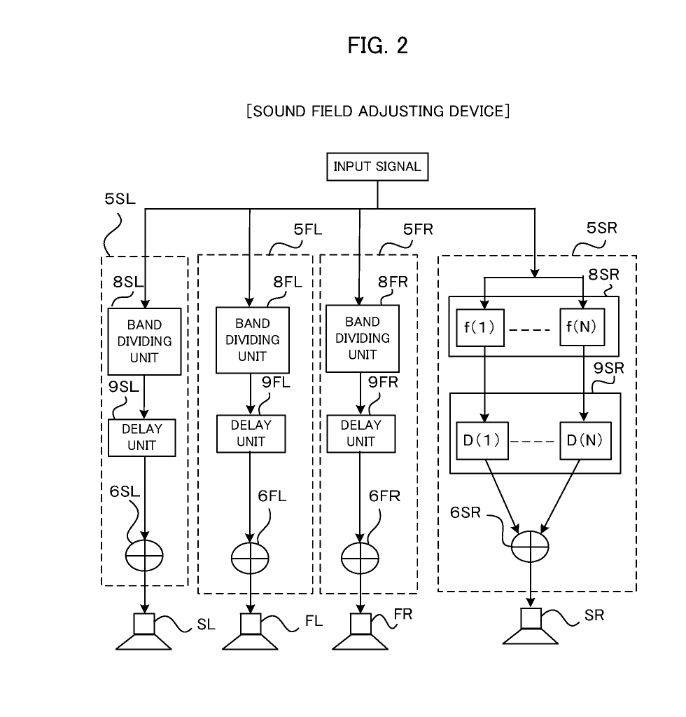

FIG. 2 schematically shows a configuration of the sound field adjusting device. An input signal from an acoustic source not shown is inputted to the signal processing units 5SL, 5FL, 5FR and 5SR. In the following description, the signal processing units 5SL to 5SR are simply referred to as “the signal processing unit 5” if they are referred to without distinction, and particular one of the signal processing units is referred to with the suffix such as “the signal processing unit 5SL”. The same is true of other components.

The signal processing unit 5 applies the delay control processing to the input signal, and supplies the signal after the delay processing to the speaker. As illustrated, the signal processing unit 5 includes a mixer 6, a band dividing unit 8 and a delay unit 9. In the signal processing unit 5, the input signal is supplied to the band dividing unit 8. The band dividing unit 8 includes a plurality of frequency band dividing filters, and divides the input signal into the signals of predetermined plural frequency bands. Specifically, the band dividing unit 8 sets each frequency band width to ⅓ octave, and sets the center frequencies f(1)-f(N) of the respective frequency bands to 250 Hz-1 kHz.

The signals of the respective frequency bands thus divided are supplied to the delay unit 9. The delay unit 9 gives the delays of the different or same delay amounts to the signals of the respective frequency bands, and outputs them to the mixer 6. The mixer 6 mixes the signals given by the delay unit 9, and outputs it to the speaker.

Out of the plural delay units 9, the delay unit 9 which gives the delay of the same delay amount to all the frequency bands of the input signal corresponds to a constant delay unit, and the delay unit 9 which gives the delay of the different delay amounts to the respective frequency bands of the input signal corresponds to a frequency band dependent delay unit.

[Method of Determining Delay Amount]

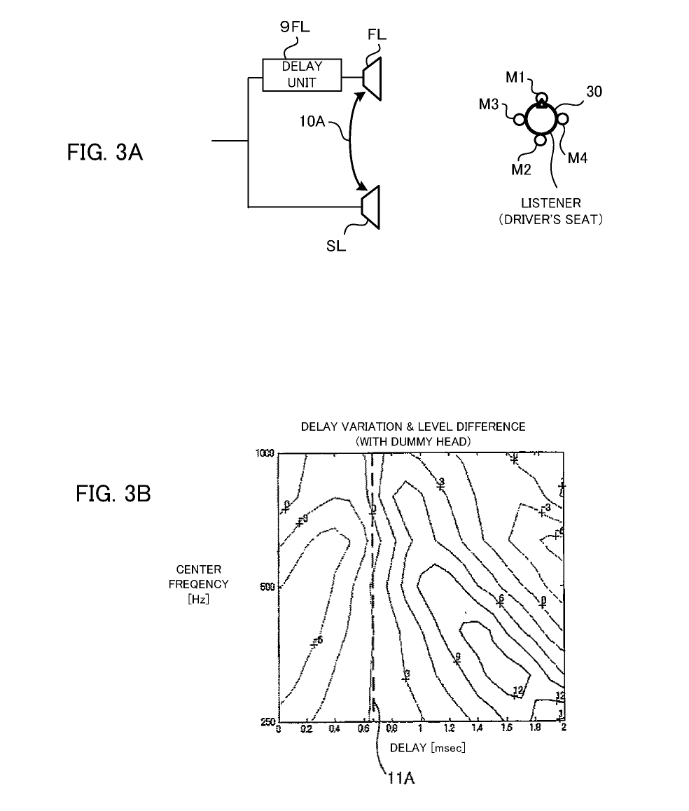

Next, the method of determining the delay amounts for the respective speaker pairs will be described with reference to FIGS. 3 to 5. At the time of determining the delay amounts for the respective speaker pairs, the sound field adjusting device measures the level difference and determines the delay amount. At the time of determining the delay amounts for the speaker pair 10B, which is the speaker pair parallel with the left-right direction of the listener, the sound field adjusting device determines the delay amount based on the level difference at the microphones arranged on the left and the right of the listener. At the time of determining the delay amount for the speaker pair 10A and 10C, which are the speaker pairs parallel with the front-rear direction of the listener, the sound field adjusting device determines the delay amount based on the level difference at the microphones arranged on the front and the rear of the listener.

First, the description will be given of a method of determining the time difference to be given to the signals supplied to the speaker pair 10A, with reference to FIGS. 3A and 3B. As shown in FIG. 3A, by measuring the pink noise outputted from the speakers FL and SL of the sound field adjusting device, the sound field adjusting device measures the level difference between the microphones M1 and M2 attached to the dummy head 30, and determines the time difference to be given to the signals supplied to the speaker pair 10A based on the result of the measurement. It is noted that the microphones M1 to M4 are connected to the sound field adjusting device.

The sound field adjusting device generates the pink noise serving as a signal used for measurement, and makes the speakers FL and SL output the pink noise simultaneously. Then, the sound field adjusting device collects the pink noise by the microphone M1 and M2 and detects the level difference.

When the level difference does not reach a predetermined threshold (e.g., zero), the delay unit 9FL of the sound field adjusting device varies the delay amount. Then, the sound field adjusting device detects the level difference again. The sound field adjusting device repeats varying the delay amount and detecting the level difference until the level difference reaches the above-mentioned threshold. FIG. 3B shows the distribution of the level difference when the delay amount of each frequency band is varied. In FIG. 3B, the graph 11A indicates the delay amount with which the level difference between the microphones M1 and M2 becomes zero.

According to the graph 11A shown in FIG. 3B, the delay amount with which the level difference between the microphones M1 and M2 becomes zero is 0.7 msec, regardless of the frequency band, and therefore the sound field adjusting device sets the delay amount of the delay unit 9FL to 0.7 msec for all the frequency bands. By this, the sound field adjusting device can give the time difference to the signals supplied to the speaker pair 10A.

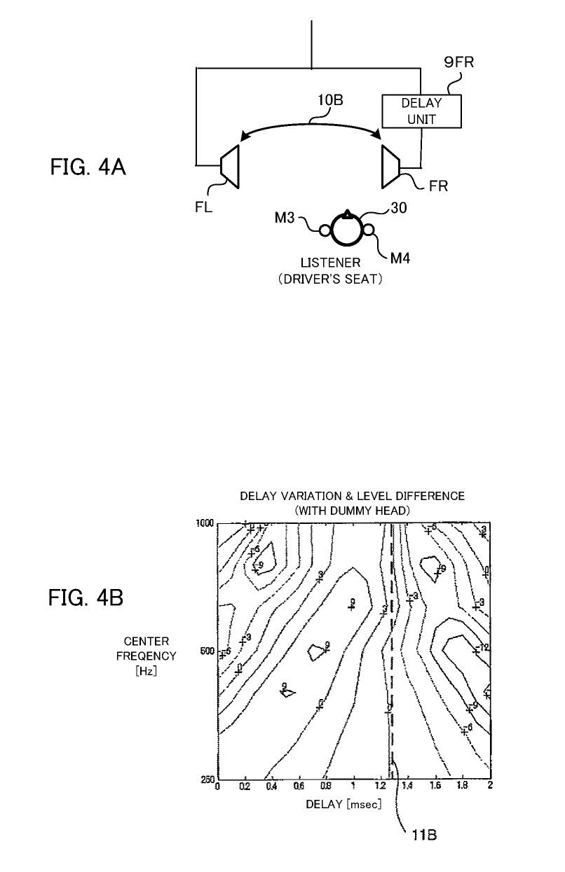

Next, the method of determining the time difference given to the signals supplied to the speaker pair 10B will be described with reference to FIGS. 4A and 4B. As shown in FIG. 4A, by measuring the pink noise outputted from the speakers FL and FR of the sound field adjusting device, the sound field adjusting device measures the level difference between the microphones M3 and M4 attached to the dummy head 30 and determines the time difference to be given to the signals supplied to the speaker pair 10B.

The sound field adjusting device generates the pink noise serving as a signal used for measurement, and outputs the pink noise from the speakers FL and FR simultaneously. Then, the sound field adjusting device collects the pink noise from the microphones M3 and M4 and detects the level difference. If the level difference does not reach the predetermined threshold value, the delay unit 9FR of the sound field adjusting device varies the delay amount. Then, the sound field adjusting device detects the level difference again. In this way, the sound field adjusting device repeats varying the delay amount and detecting the level difference until the level difference reaches the threshold value. FIG. 4B shows the distribution of the level difference when the delay amount of each frequency band is varied. In FIG. 4B, the graph 11B indicates the delay amount with which the level difference between the microphones M3 and M4 becomes zero.

According to the graph 11B shown in FIG. 4B, the delay amount with which the level difference between the microphones M3 and M3 becomes zero is 1.3 msec regardless of the frequency band, and therefore the sound field adjusting device sets the delay amount of the delay unit 9FR to 1.3 msec for all the frequency bands. By this, the sound field adjusting device can give the time difference to the signals supplied to the speaker pair 10B.

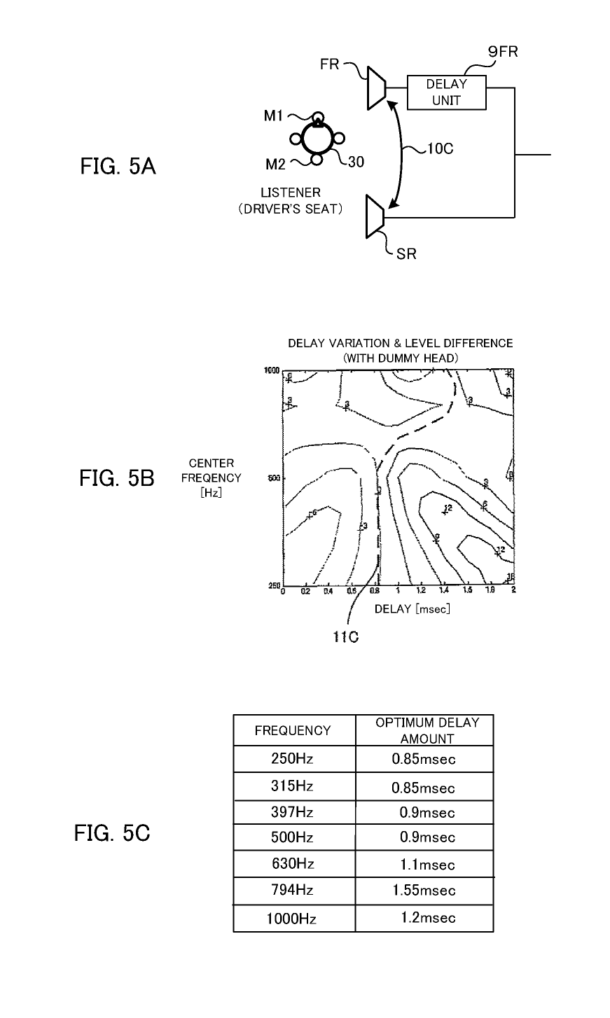

Next, the method of determining the time difference given to the signals supplied to the speaker pair 10C will be described with reference to FIGS. 5A to 5C. As shown in FIG. 5A, by measuring the pink noise outputted from the speakers FR and SR of the sound field adjusting device, the sound field adjusting device measures the level difference between the microphones M1 and M2 attached to the dummy head 30 and determines the time difference to be given to the signals supplied to the speaker pair 10C.

The sound field adjusting device generates the pink noise serving as a signal used for measurement, and outputs the pink noise from the speakers FR and SR simultaneously. Then, the sound field adjusting device collects the pink noise from the microphones M1 and M2 and detects the level difference. If the level difference does not reach the predetermined threshold value, the delay unit 9FR of the sound field adjusting device varies the delay amount. Then, the sound field adjusting device detects the level difference again. In this way, the sound field adjusting device repeats varying the delay amount and detecting the level difference until the level difference reaches the threshold value. FIG. 5B shows the distribution of the level difference when the delay amount of each frequency band is varied. In FIG. 5B, the graph 11C indicates the delay amount with which the level difference between the microphones M1 and M2 becomes zero.

According to the graph 11C shown in FIG. 5B, the delay amount with which the level difference becomes zero is different dependently upon the frequency band. FIG. 5C shows a table indicating the delay amounts with which the level difference at each frequency band becomes zero. As shown in FIGS. 5B and 5C, an optimum delay amount with which the level difference becomes zero is approximately 0.85 msec until the frequency becomes 500 Hz, but the optimum delay amount gradually increases if the frequency exceeds 500 Hz. Namely, the optimum delay amount for the frequency band equal to or higher than 500 Hz (e.g., 630 Hz) is larger than the optimum delay amount for the frequency band lower than 500 Hz.

The sound field adjusting device sets the delay amount of the delay unit 9FR to be different dependently upon the frequency band based on the graph 11C and thereby gives the time difference to the signals supplied to the speaker pair 10C.

Next, the description will be given of the procedure of determining the delay amount given by the sound field adjusting device. First, the sound field adjusting device determines the proximity speaker pair. In this embodiment, the sound field adjusting device determines the speaker pair 10C as the proximity speaker pair. Then, the sound field adjusting device specifies the speaker farthest from the listener position. In this embodiment, the sound field adjusting device determines the speaker SL as the farthest speaker. Then, the sound field adjusting device sets no delay to the delay unit 9SL connected to the farthest speaker SL, and sets the delay amount 0.7 msec to the delay unit 9FL. Thus, the sound field adjusting device can give the time difference determined by the above description referring to FIGS. 3A and 3B to the speaker pair 10A.

Then, the sound field adjusting device sets, to the delay unit 9FR, the delay amount obtained by adding the delay amount determined in the description referring to FIGS. 4A and 4B to the delay amount set to the delay unit 9FL. In this embodiment, the delay amount set to the delay unit 9FR is 2.0 msec, obtained by adding the delay amount 1.3 msec determined in the description referring to FIGS. 4A and 4B to the delay amount 0.7 msec set to the delay unit 9FL. Thus, the sound field adjusting device can give the time difference determined in the description referring to FIGS. 4A and 4B to the speaker pair 10B.

Then, the sound field adjusting device sets the time difference determined in the description referring to FIGS. 5A to 5C to the speaker pair 10C. In this embodiment, the delay amount for the delay unit 9SR is a difference value of the delay amount set to the delay unit 9FR and the delay amount based on the graph 11C of FIG. 5B. Thus, the sound field adjusting device can give the time difference determined in the description referring to FIGS. 5A to 5C to the speaker pair 10C. It is noted that the time difference different between the frequency bands is given to the speaker pair 10C.

As described above, the sound field adjusting device can give the time differences determined in the description of FIGS. 3 to 5 to the speaker pairs 10A to 10C.

[Comparison of the Present Invention with a Sound Field Correction Method which Sets the Delay Amount Without Consideration of the Influence by the Head]

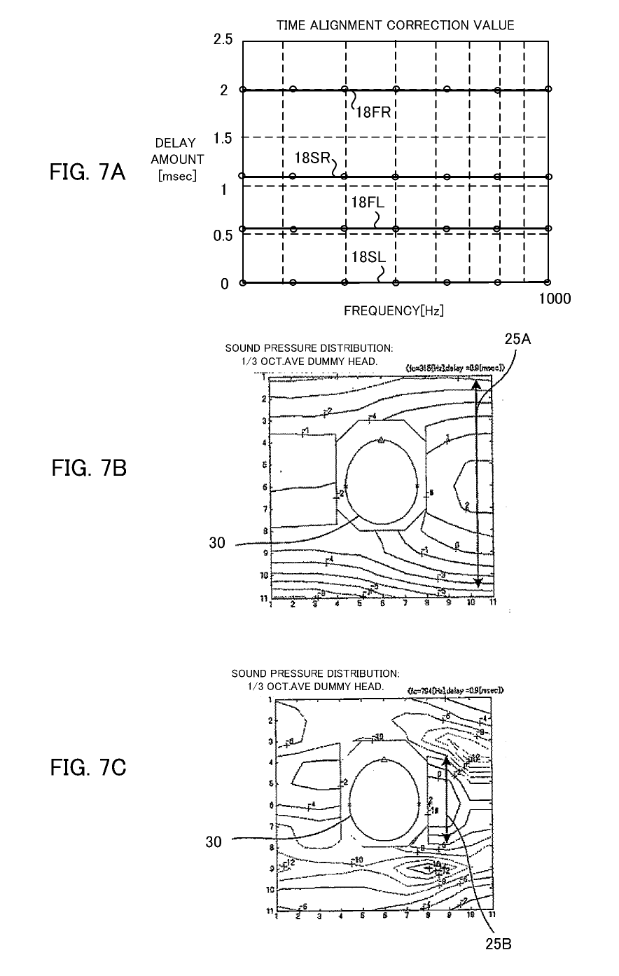

The description will be given of the comparison of the present invention with a sound field correction which sets the delay amount without consideration of the influence by the head. First, as shown in FIG. 7A, as an example of a method of setting the delay amount without consideration of the influence by the head, it is assumed that a constant delay amount is uniformly given to the signals outputted by the respective speakers for all the frequency bands, regardless of the frequency being high or low. For example, the delay amount 2 msec is given to the signal outputted from the speaker FR based on the graph 18FR, the delay amount 1.1 msec is given to the signal outputted from the speaker SR based on the graph 18SR, the delay amount 0.55 msec is given to the signal outputted from the speaker FL based on the graph 18FL, and no delay is given to the signal outputted from the speaker SL. In this case, based on the positional relationship between the listener and the respective speakers, such delay amounts that the peak of the interference comes to the listener position are set.

FIG. 7B is a graph indicating the sound pressure distribution of the signal of the frequency band 315 Hz near the dummy head 30. In addition, FIG. 7B is the sound pressure distribution in the case where the time difference between the signal outputted from the speaker FR and the signal outputted from the speaker SR is 0.9 msec. The vertical axis and the horizontal axis indicate the position near the dummy head 30, and the contour lines in the graph indicate the sound pressure levels. In this case, the peak stripes 25A, which are the contour lines belonging to the high sound pressure level range (−4 dB to 2 dB) exist in front and behind the dummy head 30. Therefore, the sound pressure is uniform in front and behind the dummy head 30.

FIG. 7C is a graph indicating the sound pressure distribution of the signal of the frequency band 794 Hz near the dummy head 30. FIG. 7C is the sound pressure distribution in the case where the time difference between the signal outputted from the speaker FR and the signal outputted from the speaker SR is 0.9 msec. According to the graph of FIG. 7C, the peak stripes 25B, which are the contour lines belonging to the high sound pressure level range (−4 dB to 2 dB), exist at the center position of the dummy head 30. In this case, it is presumed that the signal is strongly influenced by the dummy head 30 near the dummy head 30 and consequently the level difference is disturbed in front and behind the dummy head 30. Also, if the driver actually sits on the driver's seat, the sound pressure level difference is disturbed in front and behind the driver's head due to the driver's head. As shown in FIG. 7B, as to the signal of low frequency band, the sound pressure level difference becomes uniform even if the constant delay amount is given to the signals regardless of frequency being high or low.

However, as shown in FIG. 7C, as to the signal of high frequency band, if the constant delay amount is applied to the signal regardless of the frequency being high or low, the peak stripes 25B locates at the center position of the dummy head 30 and the signal is influenced by the dummy head 30, thereby disturbing the sound pressure level in front and behind the dummy head 30.

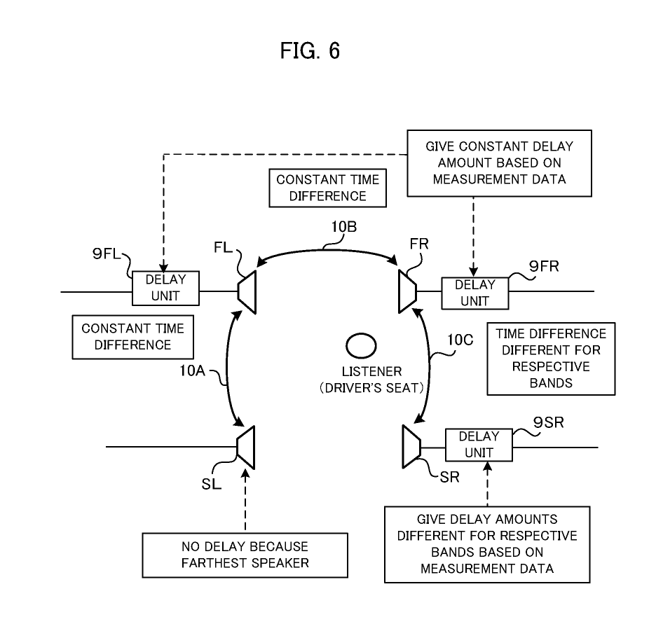

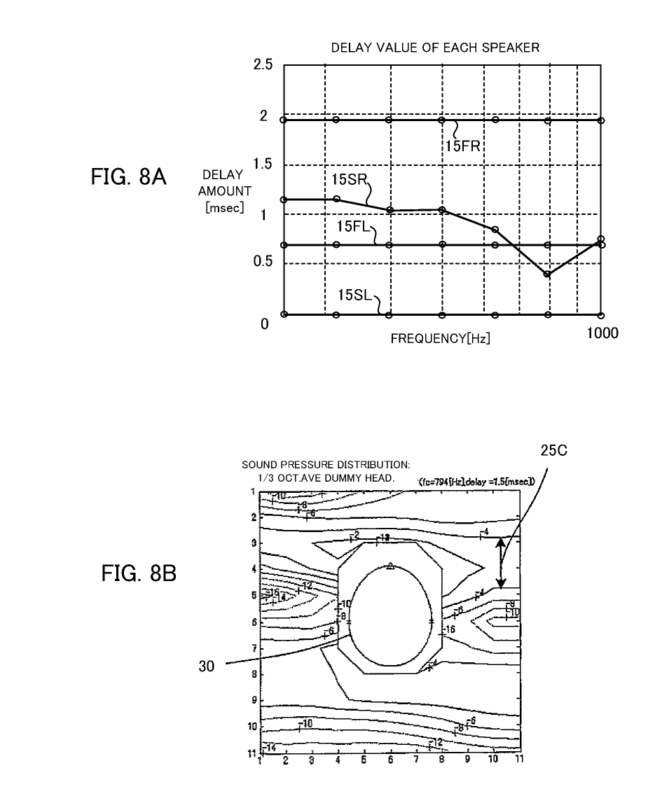

Next, it is assumed that the delay amount is determined by the method of determining the delay amount according to the present invention. When the delay amount of the delay unit 9 is determined by the method described with reference to FIG. 6, the delay amounts of the respective delay units 9 become as shown by the graph in FIG. 8A. Specifically, the delay amount shown by the graph 15FL is set to the delay unit 9FL, the delay amount shown by the graph 15FR is set to the delay unit 9FR, and the delay amount shown by the graph 15SR is set to the delay unit 9SR. Therefore, as shown by the graph 15SR, the delay amounts different for the respective frequency bands are set to the delay unit 9SR. It is noted that no delay is set to the delay unit 9SL as shown by the graph 15SL.

FIG. 8B is a graph indicating the sound pressure distribution of the signal of the frequency band 794 Hz near the dummy head 30. In addition, FIG. 8B is the graph in the case where the time difference between the signal outputted from the speaker FR and the signal outputted from the speaker SR is 0.9 msec. The vertical axis and the horizontal axis indicate the position near the dummy head 30, and the contour lines in the graph indicate the sound pressure levels.

In this case, the peak stripes 25, which are the contour lines belonging to the high sound pressure level range (−4 dB to 2 dB), exist in front of the dummy head 30. By determining the delay amount of the delay unit 9 by the method described with reference to FIG. 6 and giving the time differences different for the respective frequency bands to the speaker pair 10C near the dummy head 30, the peak stripes 25C exist in front of the dummy head 30.

Therefore, when the delay amount is determined by the method of determining the delay amount according to the present invention, the peak stripes 25C are located at the position less influenced by the dummy head 30, and therefore the level difference is not disturbed in front and behind the dummy head 30.

As described above, since the sound field adjusting device can prevent the influence to the listener position by the dummy head 30 by giving the delay amounts different for the respective frequency bands to the signals outputted by the proximity speaker pair, the sound field can be appropriately adjusted in comparison with the case where a uniform delay amount is given to the signals for all the frequency bands.

In addition, as to the signal outputted from the proximity speaker pair, since the sound field adjusting device gives, to the signal of frequency higher than a predetermined frequency band, the delay amount larger than that given to the signal of low frequency, it can be avoided that the sound pressures difference occurs due to the influence by the head of a person existing at the listening position.

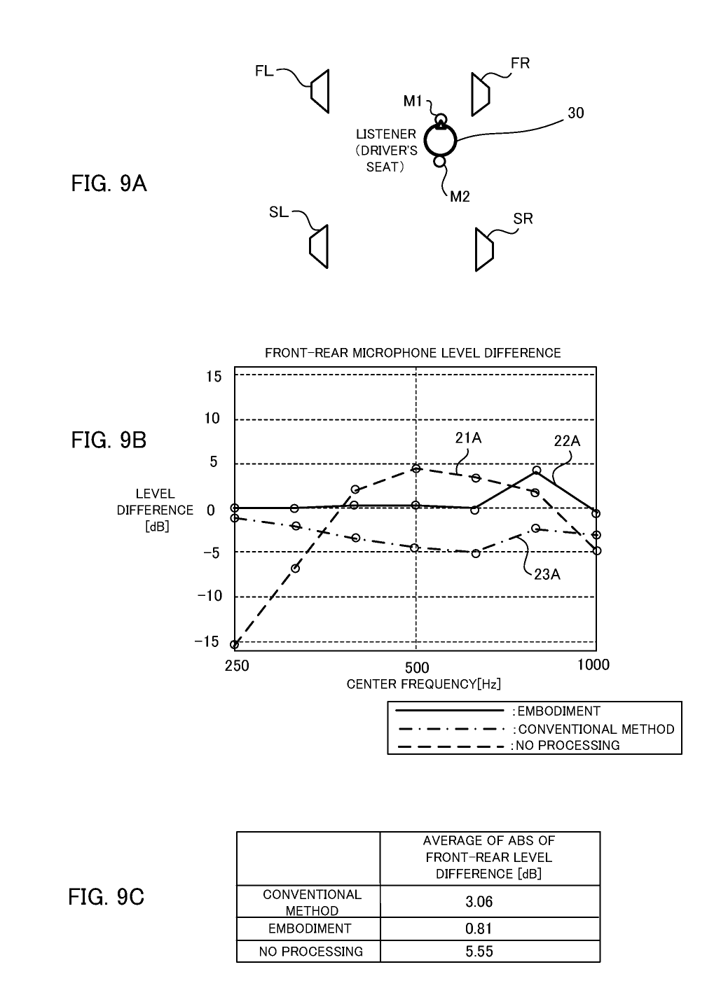

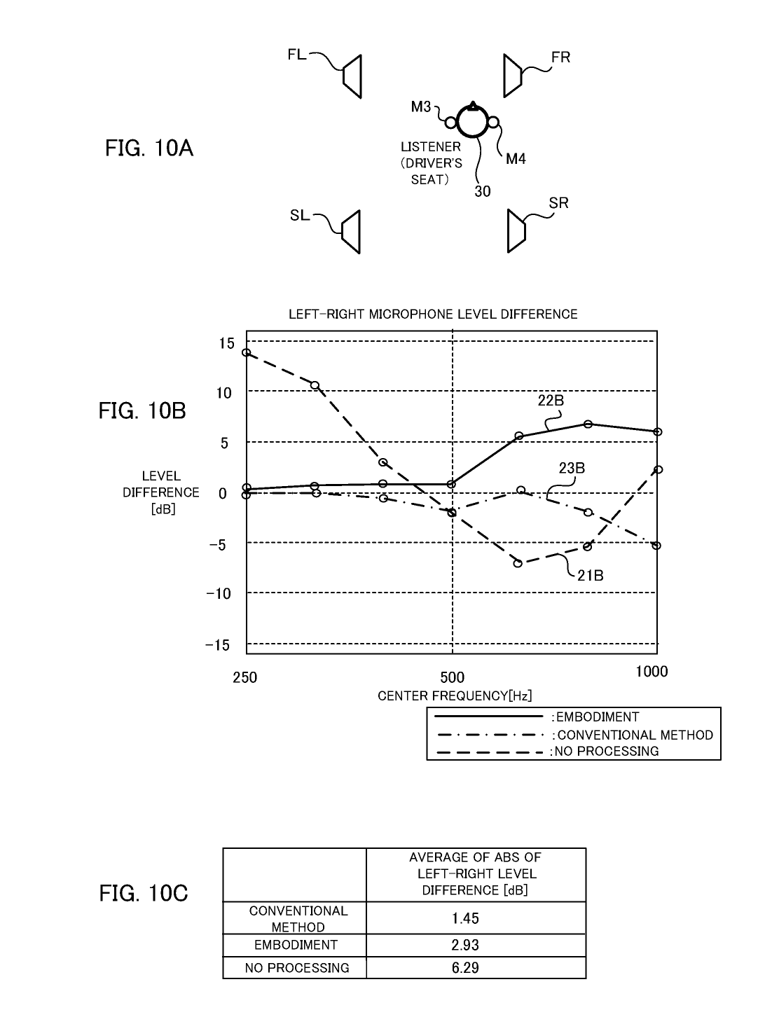

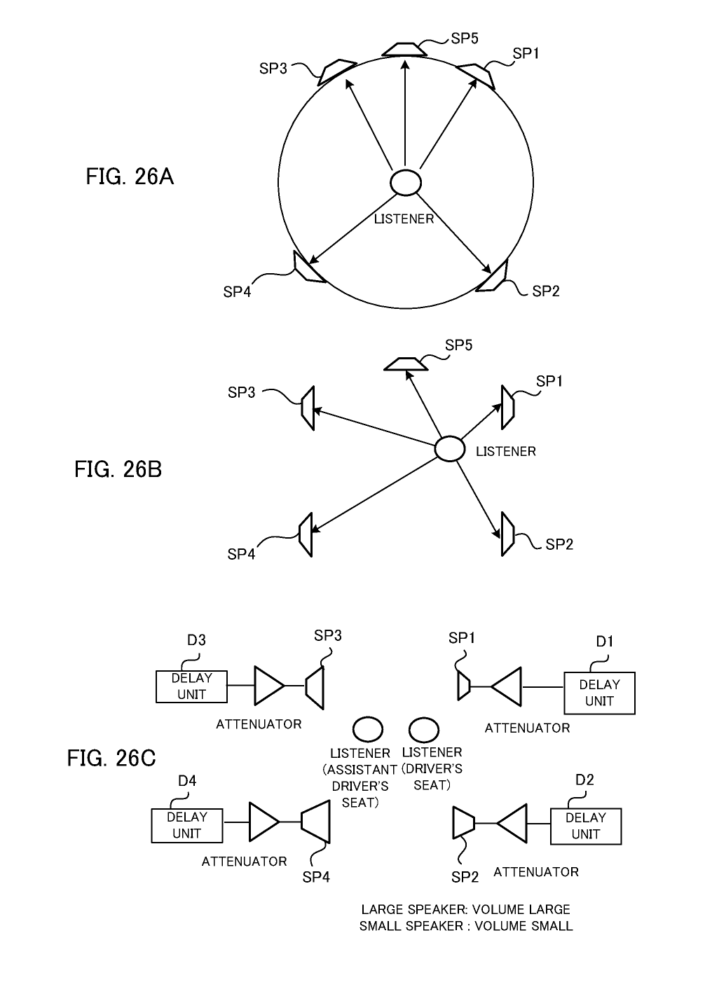

Next, the description will be given of the measurement result of the front-rear microphone level difference and the left-right microphone level difference, with reference to FIGS. 9 and 10, in cases where the sound field adjustment according to the embodiment is performed at the listener position, where the conventional sound field correction is performed and where the correction process is not performed. The conventional sound field correction mentioned herein is the sound field correction which adjusts the levels and gives a constant delay amount regardless of the frequency being high or low. Namely, it is to adjust the sound pressure balance at the driver's seat by reducing the volume of the input signal for the speaker near the driver's seat in comparison with the speaker far from the driver's seat and by performing the time alignment correction by the delay units D1 to D4 shown in FIG. 26C.

First, the measurement result of the front-rear microphone level difference will be described with reference to FIGS. 9A to 9C. As shown in FIG. 9A, the sound pressure difference between the microphones M1 and M2 arranged in front and behind the dummy head 30 is measured. The graph of the measurement result is shown in FIG. 9B. The graph 21A is for the case where the sound field correction is not performed, the graph 22A is for the case where the sound field adjustment according to this embodiment is performed, and the graph 23A is for the case where the conventional sound field correction is performed.

In addition, FIG. 9C shows the average values of the front-rear level difference in the cases where the sound field adjustment according to this embodiment is performed, where the conventional sound field correction is performed and where the correction process is not performed.

By comparing the graph 22A in the case where the sound field adjustment according to this embodiment is performed with the graphs 21A and 23A, the front-rear microphone level difference is almost zero. Therefore, the sound field adjusting device of this embodiment can make the front-rear level difference at the listener position almost zero in comparison with the conventional technique, and can appropriately adjust the sound field.

Next, the measurement result of the left-right microphone level difference will be described with reference to FIGS. 10A to 10C. As shown in FIG. 10A, the sound pressure level difference between the microphones M3 and M4 arranged on the left and the right of the dummy head 30 at the listener position is measured. The graph of the measurement result is shown in FIG. 10B.

The graph 21B is the graph in a case where the sound field correction is not performed, the graph 22B is a graph in a case where the sound field adjustment according to this embodiment is performed, and the graph 23B is a graph in a case where the conventional sound field correction is performed.

FIG. 10C shows the average values of the left-right level difference in the cases where the sound field adjustment according to this embodiment is performed, where the conventional sound field correction is performed and where the correction process is not performed.

By comparing the case where the conventional sound field correction is performed with the case where the sound field adjustment according to this embodiment is performed, the average value of the left-right level difference is smaller in the case where the conventional sound field correction is performed. However, the average of the absolute values of the left-right level difference in the case where the sound field adjustment according to this embodiment is performed is equal to or smaller than 3 dB, and it is assumed to be within a range not substantially problematic for the listener. Therefore, it is assumed that there is no substantial difference.

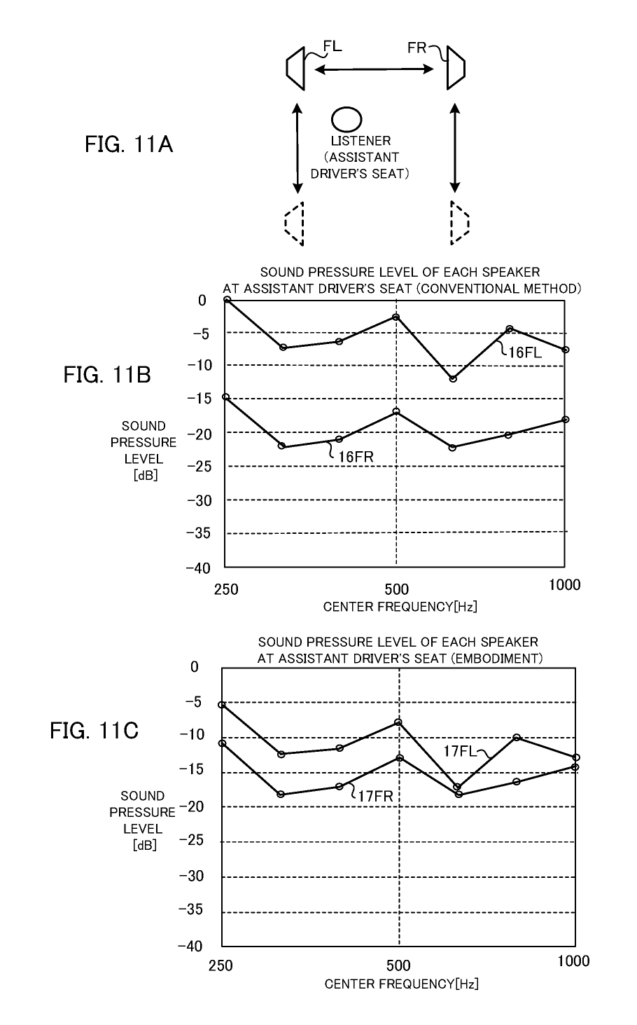

Next, the description will be given of the comparison of the sound pressure levels of outputs from the speakers FR and FL at the assistant driver's seat shown in FIG. 11A, with reference to FIGS. 11B and 11C.

FIG. 11B is a graph of the sound pressure level of the outputs from the speakers FR and FL at the assistant driver's seat when the conventional sound field correction is performed. The graph 16FR indicates the sound pressure level of the speaker FR in each frequency, and the graph 16FL indicates the sound pressure level of the speaker FL in each frequency. In average, the sound pressure level difference between the speakers FR and FL is 13.6 dB.

FIG. 11C is a graph of the sound pressure level of the outputs from the speakers FR and FL at the assistant driver's seat according to the sound field adjusting device of the present invention. The graph 17FR indicates the sound pressure level of the speaker FR in each frequency, and the graph 17FL indicates the sound pressure level of the speaker FL in each frequency. In average, the sound pressure level difference between the speakers FR and FL is 4.4 dB. Therefore, the sound field adjusting device according to the present invention can suppress the sound pressure level difference at the assistant driver's seat in comparison with the case where the conventional sound field correction is performed.

As described above, since the sound field adjusting device according to the present invention adjusts the sound pressure balance by the signal interference, without adjusting the level, it can keep the sound field correction effect similar to that of the conventional sound field correction at the listening position of the driver's seat, and can further improve the adverse effect at other listening positions (e.g., the assistant driver's seat) in comparison with the conventional sound field correction.

### 2nd Embodiment

Next, the second embodiment of the present invention will be described.

[Speaker Layout]

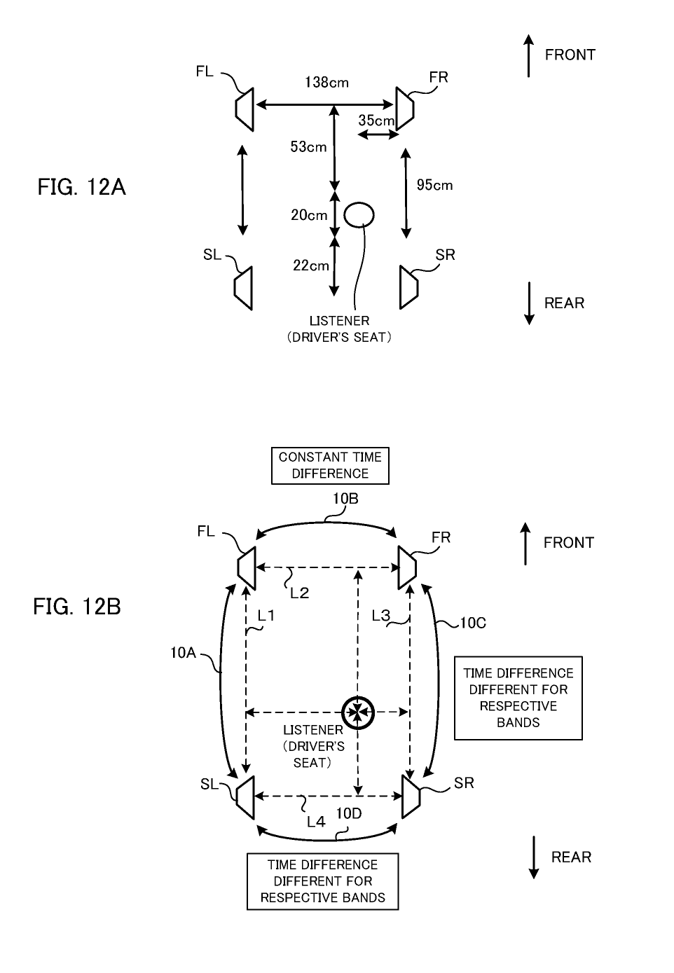

FIG. 12A shows a speaker layout of the sound field adjusting device according to the second embodiment. FIG. 12A schematically shows the speakers and the listening position (listener position) in the vehicle compartment. The configuration of the speakers is the same as that of the first embodiment shown in FIG. 1. However, the second embodiment supposes a smaller vehicle than that of the first embodiment, and the distances between the speakers and the listening position are shorter. Particularly, in comparison with the first embodiment, the distance between the rear speaker pair 10D and the listening position is near. The positional relationship between four speakers and the driver's seat is as indicated by the numerical values shown in FIG. 12A.

By using FIG. 12B, the outline of the sound field adjusting device according to the second embodiment will be described. The sound field adjusting device according to the second embodiment gives the delay amounts different for the respective frequency bands to the signals supplied to the speaker pair 10D serving as the proximity speaker pair. In addition, in the second embodiment, the delay amounts different for the respective frequency bands are given to the signals supplied to the speaker pair 10C, for which the vertical distance from the listening position is next closest, except for the proximity speaker pair 10D. On the other hand, a constant delay amount is given to the signals supplied to the speaker pair 10B, regardless of the frequency band. It is noted that the speaker pair 10A is eliminated from the speaker pairs subjected to the examination at the time of determining the delay amounts for the respective speakers. By eliminating the speaker pair, which is far from the listener position and which has less influence to the adjustment of the sound pressure balance, from the speaker pairs subjected to the examination, the sound field adjusting device adjusts the sound pressure balance more appropriately.

[Method of Determining Delay Amount]

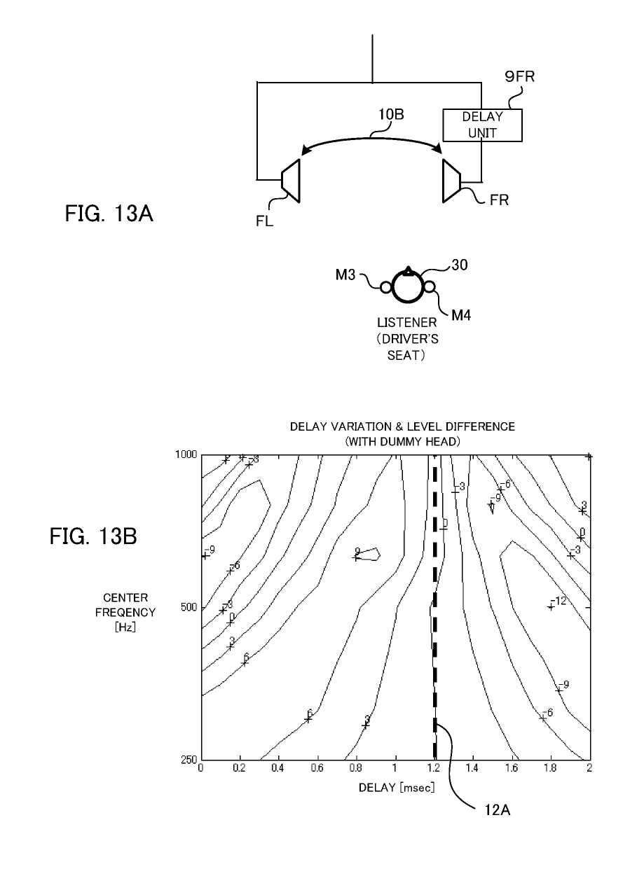

Next, the method of determining the delay amounts for the respective speaker pairs will be described with reference to FIGS. 13 to 15. At the time of determining the delay amounts for the respective speaker pairs, the sound field adjusting device measures the level difference and determines the delay amount. At the time of determining the delay amounts for the speaker pairs 10B and 10D, which are the speaker pairs parallel with the left-right direction of the listener, the sound field adjusting device determines the delay amount based on the level difference at the microphones arranged on the left and the right of the listener. At the time of determining the delay amount for the speaker pair 10C, which is the speaker pair parallel with the front-rear direction of the listener, the sound field adjusting device determines the delay amount based on the level difference at the microphones arranged on the front and the rear of the listener.

First, the description will be given of a method of determining the time difference to be given to the signals supplied to the speaker pair 10B. As shown in FIG. 13A, by measuring the pink noise outputted from the speakers FL and FR of the sound field adjusting device, the sound field adjusting device measures the level difference between the microphones M3 and M4 attached to the dummy head 30, and determines the time difference to be given to the signals supplied to the speaker pair 10B based on the result of the measurement. It is noted that the microphones M1 to M4 are connected to the sound field adjusting device.

The sound field adjusting device generates the pink noise serving as a signal used for measurement, and outputs the pink noise from the speakers FL and FR simultaneously. Then, the sound field adjusting device collects the pink noise by the microphones M3 and M4 and detects the level difference.

When the level difference does not reach a predetermined threshold (e.g., zero), the delay unit 9FR of the sound field adjusting device varies the delay amount. Then, the sound field adjusting device detects the level difference again. The sound field adjusting device repeats varying the delay amount and detecting the level difference until the level difference reaches the above-mentioned threshold value. FIG. 13B shows the distribution of the level difference when the delay amount of each frequency band is varied. In FIG. 13B, the graph 12A indicates the delay amount with which the level difference between the microphones M3 and M4 becomes zero.

According to the graph 12A shown in FIG. 13B, the delay amount with which the level difference between the microphones M3 and M4 becomes zero is 1.2 msec, regardless of the frequency band, and therefore the sound field adjusting device sets the delay amount of the delay unit 9FR to 1.2 msec for all the frequency bands. By this, the sound field adjusting device can give the time difference to the signals supplied to the speaker pair 10B.

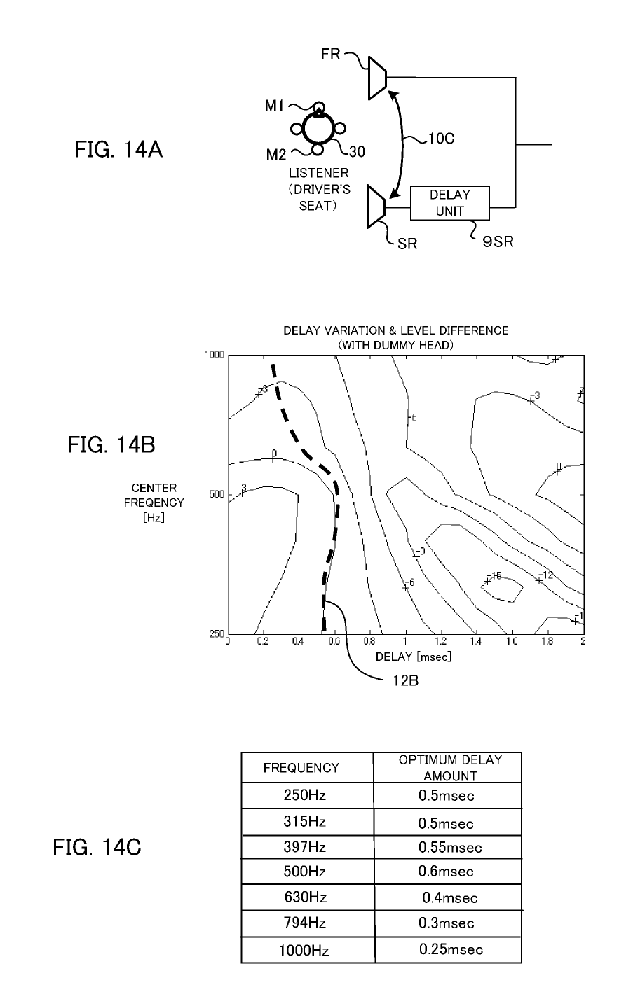

Next, the method of determining the time difference given to the signals supplied to the speaker pair 10C will be described with reference to FIGS. 14A and 14B. As shown in FIG. 14A, by measuring the pink noise outputted from the speakers FR and SR of the sound field adjusting device, the sound field adjusting device measures the level difference between the microphones M1 and M2 attached to the dummy head 30 and determines the time difference to be given to the signals supplied to the speaker pair 10C.

The sound field adjusting device generates the pink noise serving as a signal used for measurement, and outputs the pink noise from the speakers FR and SR simultaneously. Then, the sound field adjusting device collects the pink noise from the microphones M1 and M2 and detects the level difference. If the level difference does not reach the predetermined threshold value, the delay unit 9SR of the sound field adjusting device varies the delay amount. Then, the sound field adjusting device detects the level difference again. In this way, the sound field adjusting device repeats varying the delay amount and detecting the level difference until the level difference reaches the threshold value. FIG. 14B shows the distribution of the level difference when the delay amount of each frequency band is varied. In FIG. 14B, the graph 12B indicates the delay amount with which the level difference between the microphones M1 and M2 becomes zero.

According to the graph 12B shown in FIG. 14B, the delay amount with which the level difference becomes zero is different for the respective frequency bands. FIG. 14C shows a table of the delay amounts with which the level difference in the respective frequency bands becomes zero. As shown in FIGS. 14B and 14C, the optimum delay amount, with which the level difference becomes zero, is approximately 0.5 to 0.6 msec until the frequency becomes 500 Hz, but the optimum delay amount gradually decreases as the frequency exceeds 500 Hz. Namely, the optimum delay amount for the frequency bands equal to or higher than 500 Hz (e.g., 630 Hz) is smaller than the optimum delay amount for the frequency bands lower than 500 Hz (e.g., 630 Hz).

The sound field adjusting device gives the time difference to the signals supplied to the speaker pair 10C by setting the delay amounts different for the respective frequency bands to the delay unit 9SR based on the graph 12B.

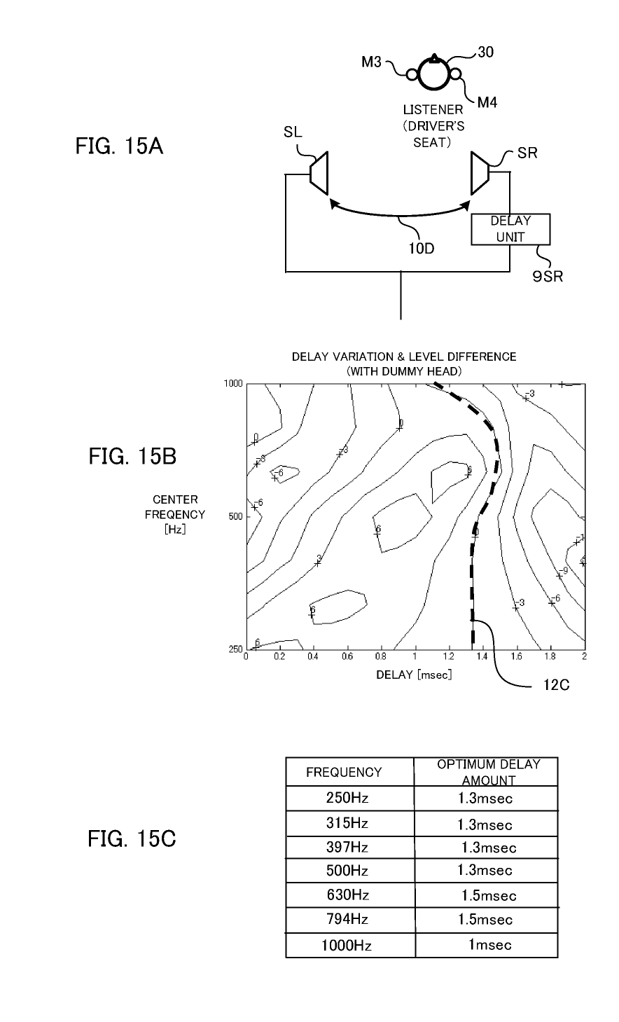

Next, the method of determining the time difference given to the signals supplied to the speaker pair 10D will be described with reference to FIGS. 15A to 15C. As shown in FIG. 15A, by measuring the pink noise outputted from the speakers SL and SR of the sound field adjusting device, the sound field adjusting device measures the level difference between the microphones M3 and M4 attached to the dummy head 30 and determines the time difference to be given to the signals supplied to the speaker pair 10D.

The sound field adjusting device generates the pink noise serving as a signal used for measurement, and outputs the pink noise from the speakers SL and SR simultaneously. Then, the sound field adjusting device collects the pink noise from the microphones M3 and M4 and detects the level difference. If the level difference does not reach the predetermined threshold value, the delay unit 9SR of the sound field adjusting device varies the delay amount. Then, the sound field adjusting device detects the level difference again. In this way, the sound field adjusting device repeats varying the delay amount and detecting the level difference until the level difference reaches the threshold value. FIG. 15B shows the distribution of the level difference when the delay amount of each frequency band is varied. In FIG. 15B, the graph 12C indicates the delay amount with which the level difference between the microphones M3 and M4 becomes zero.

According to the graph 12C shown in FIG. 15B, the delay amount with which the level difference becomes zero is different for the respective frequency bands. FIG. 15C shows a table indicating the delay amounts with which the level difference at each frequency band becomes zero. As shown in FIGS. 15B and 15C, an optimum delay amount with which the level difference becomes zero is approximately 1.3 msec until the frequency becomes 500 Hz, but the optimum delay amount gradually increases if the frequency exceeds 500 Hz. Namely, the optimum delay amount for the frequency band equal to or higher than 500 Hz (e.g., 630 Hz) is larger than the optimum delay amount for the frequency band lower than 500 Hz. However, the optimum delay amount gradually decreases thereafter if the frequency approaches 1 kHz. For example, the optimum delay amount at 1 kHz is approximately 1 msec.

The sound field adjusting device sets the delay amount of the delay unit 9SR to be different for the respective frequency bands based on the graph 12C and thereby gives the time difference to the signals supplied to the speaker pair 10D.

Next, the description will be given of the procedure of determining the delay amount given by the sound field adjusting device. First, the sound field adjusting device determines the proximity speaker pair. In this embodiment, the sound field adjusting device determines the speaker pair 10D as the proximity speaker pair. Then, the sound field adjusting device specifies the speaker farthest from the listener position. In this embodiment, the sound field adjusting device determines the speaker FL as the farthest speaker. Then, the sound field adjusting device sets no delay to the delay unit 9FL connected to the farthest speaker FL, and sets the delay amount 1.2 msec to the delay unit 9FR. Thus, the sound field adjusting device can give the time difference determined by the above description referring to FIGS. 13A and 13B to the speaker pair 10B.

Then, the sound field adjusting device sets, to the delay unit 9SR, the delay amount obtained by adding the delay amount determined in the description referring to FIGS. 14A and 14C to the delay amount set to the delay unit 9FR. In this embodiment, the delay amount, obtained by adding the delay amounts different for the respective frequency bands and determined by the description referring FIGS. 14A to 14C to the delay amount 1.2 msec given to the delay unit 9FR, is given to the delay unit 9SR. Thus, the sound field adjusting device can give the time difference determined in the description referring to FIGS. 14A and 14C to the speaker pair 10C. It is noted that the time differences different for the respective frequency bands are given to the speaker pair 10C.

Then, the sound field adjusting device gives the time difference determined in the description referring to FIGS. 15A to 15C to the speaker pair 10C. In this embodiment, the delay amount for the delay unit 9SL is a difference value of the delay amount set to the delay unit 9SR and the delay amount based on the graph 12C of FIG. 15B. Thus, the sound field adjusting device can give the time difference determined in the description referring to FIGS. 15A to 15C to the speaker pair 10D. It is noted that the time differences different for the respective frequency bands are given to the speaker pair 10D.

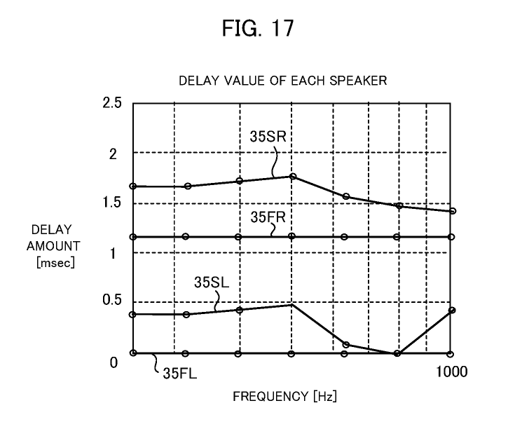

The delay amounts of the respective delay units 9 thus determined are shown by the graphs in FIG. 17. Specifically, the delay amount shown by the graph 35FR is set to the delay unit 9FR, the delay amount shown by the graph 35SR is set to the delay unit 9SR, and the delay amount shown by the graph 35SL is set to the delay unit 9SL. Therefore, as shown by the graphs 35SL and 35SR, the delay amounts different for the respective frequency bands are set to the delay units 9SL and 9SR. It is noted that no delay is set to the delay unit 9FL as shown by the graph 35FL.

As described above, the sound field adjusting device can give the time differences determined in the description referring to FIGS. 13 to 15 to the speaker pairs 10B to 10D.

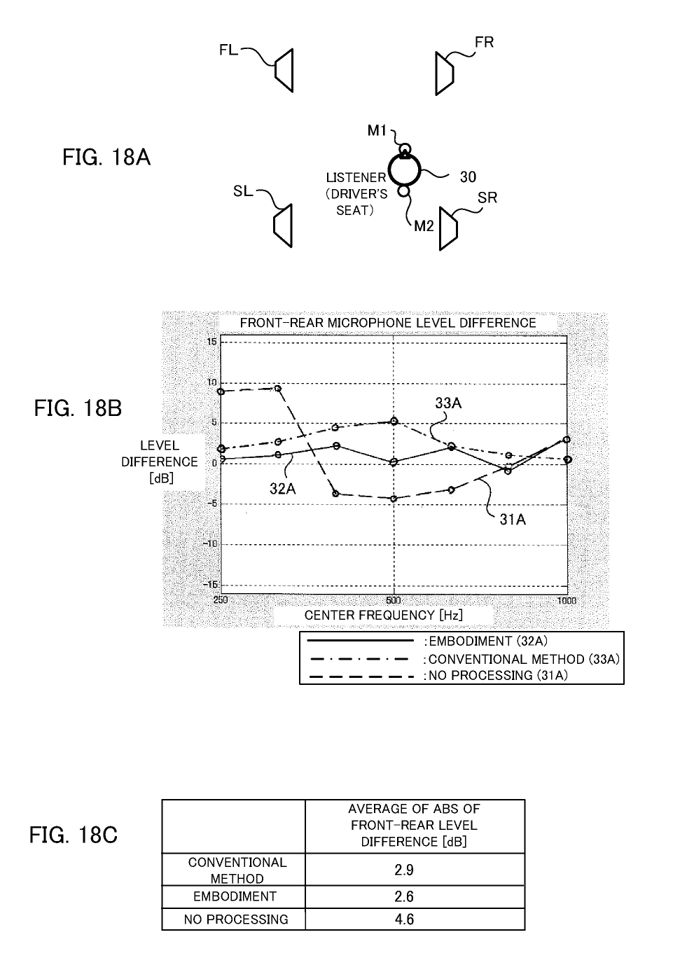

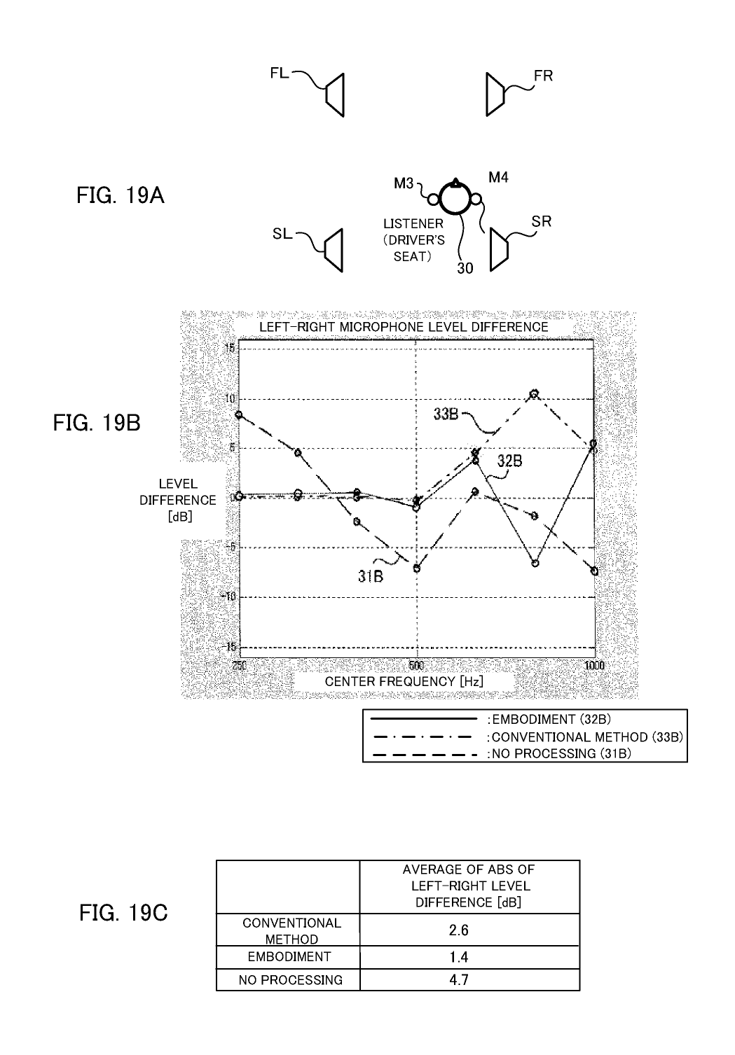

Next, the description will be given of the measurement result of the front-rear microphone level difference and the left-right microphone level difference, with reference to FIGS. 18 and 19, in cases where the sound field adjustment according to the second embodiment is performed at the listener position, where the conventional sound field correction is performed and where the correction process is not performed. Similarly to the first embodiment, the conventional sound field correction mentioned herein is the sound field correction which adjusts the levels and gives a constant delay amount regardless of the frequency being high or low.

First, the measurement result of the front-rear microphone level difference will be described with reference to FIGS. 18A to 18C. As shown in FIG. 18A, the sound pressure difference between the microphones M1 and M2 arranged in front and behind the dummy head 30 is measured. The graph of the measurement result is shown in FIG. 18B. The graph 31A is a graph in the case where the sound field correction is not performed, the graph 32A is a graph in the case where the sound field adjustment according to this embodiment is performed, and the graph 33A is a graph in the case where the conventional sound field correction is performed.

In addition, FIG. 18C shows the average values of the front-rear level difference in the cases where the sound field adjustment according to this embodiment is performed, where the conventional sound field correction is performed and where the correction process is not performed.

By comparing the graph 32A in the case where the sound field adjustment according to this embodiment is performed with the graphs 31A and 33A, the front-rear microphone level difference is smallest in the case where the sound field adjustment according to this embodiment is performed. Therefore, the sound field adjusting device of this embodiment can make the front-rear level difference at the listener position to be small in comparison with the conventional technique, and can appropriately adjust the sound field.

Next, the measurement result of the left-right microphone level difference will be described with reference to FIGS. 19A to 19C. As shown in FIG. 19A, the sound pressure level difference between the microphones M3 and M4 arranged on the left and the right of the dummy head 30 at the listener position is measured. The graph of the measurement result is shown in FIG. 19B.

The graph 31B is the graph in a case where the sound field correction is not performed, the graph 32B is a graph in a case where the sound field adjustment according to this embodiment is performed, and the graph 33B is a graph in a case where the conventional sound field correction is performed.

FIG. 19C shows the average values of the left-right level difference in the cases where the sound field adjustment according to this embodiment is performed, where the conventional sound field correction is performed and where the correction process is not performed.

By comparing the graph 32B of the case where the sound field adjustment according to this embodiment is performed is compared with the graphs 31B and 33B, the left-right microphone difference is smallest in the case where the sound field adjustment according to this embodiment is performed. Therefore, the sound field adjusting device according to this embodiment can make the left-right level difference at the listener position small in comparison with the conventional technique, and can appropriately adjust the sound field.

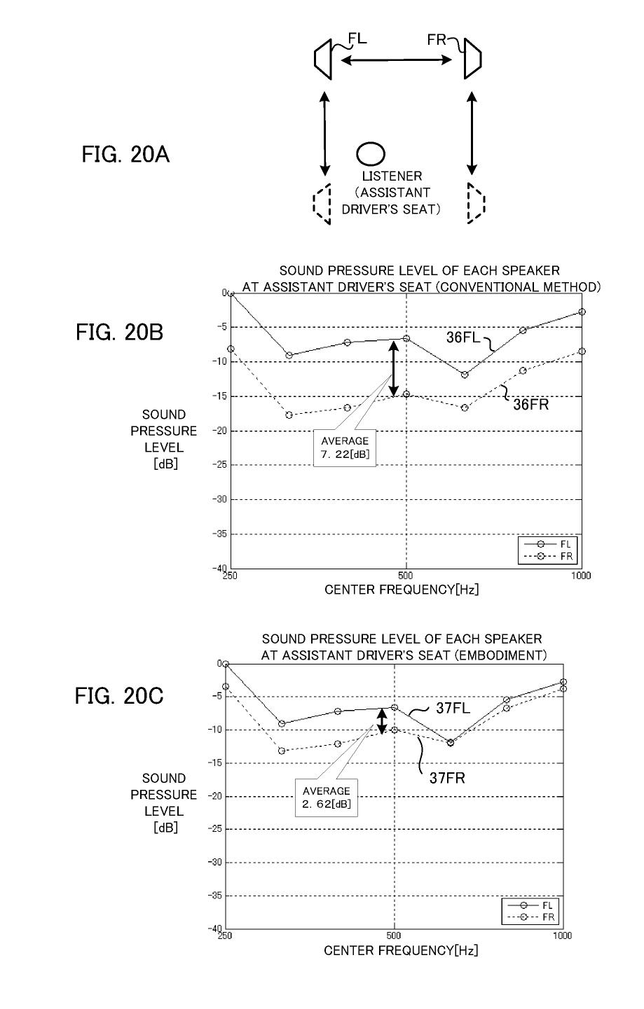

Next, the description will be given of the comparison of the sound pressure levels of outputs from the speakers FR and FL at the assistant driver's seat shown in FIG. 20A, with reference to FIGS. 20B and 20C.

FIG. 20B is a graph of the sound pressure level of the outputs from the speakers FR and FL at the assistant driver's seat when the conventional sound field correction is performed. The graph 36FR indicates the sound pressure level of the speaker FR in each frequency, and the graph 36FL indicates the sound pressure level of the speaker FL in each frequency. In average, the sound pressure level difference between the speakers FR and FL is 7.22 dB.

FIG. 20C is a graph of the sound pressure level of the outputs from the speakers FR and FL at the assistant driver's seat according to the sound field adjusting device of the present invention. The graph 37FR indicates the sound pressure level of the speaker FR in each frequency, and the graph 37FL indicates the sound pressure level of the speaker FL in each frequency. In average, the sound pressure level difference between the speakers FR and FL is 2.62 dB. Therefore, the sound field adjusting device according to this embodiment can suppress the sound pressure level difference at the assistant driver's seat in comparison with the case where the conventional sound field correction is performed.

<Relation Between Distance to Speaker Pair and Optimum Delay Amount>

Next, the description will be given of a relation between the distance to the speaker pair and the optimum delay amount. Now, in a case where the vertical distance between the speaker pair 10C, constituted by the speakers FR and SR, and the listener position are varied in the vehicle in the first embodiment shown in FIG. 1, the variation of the optimum delay amount given to the speakers FR and SR constituting the speaker pair 10C will be examined. In the following example, the values other than the vertical distance from the speaker pair 10C and the listener position are all fixed.

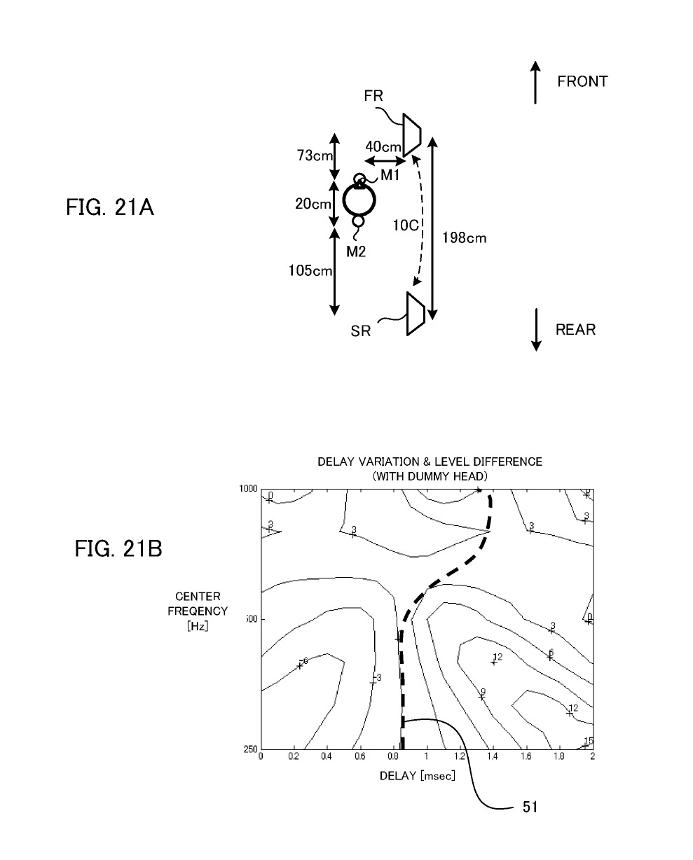

FIG. 21 shows the distribution of the level difference when the delay amounts for the respective frequency bands are varied, in the case where the vertical distance from the speaker pair 10C and the listener position is 40 cm. The broken line 51 in FIG. 21 shows the graph on which the level difference of the microphones M1 and M2 becomes zero. In this case, the optimum delay amount with which the level difference becomes zero is about 0.8 msec up to the frequency 500 Hz, but the optimum delay amount increases if the frequency exceeds the frequency 500 Hz.

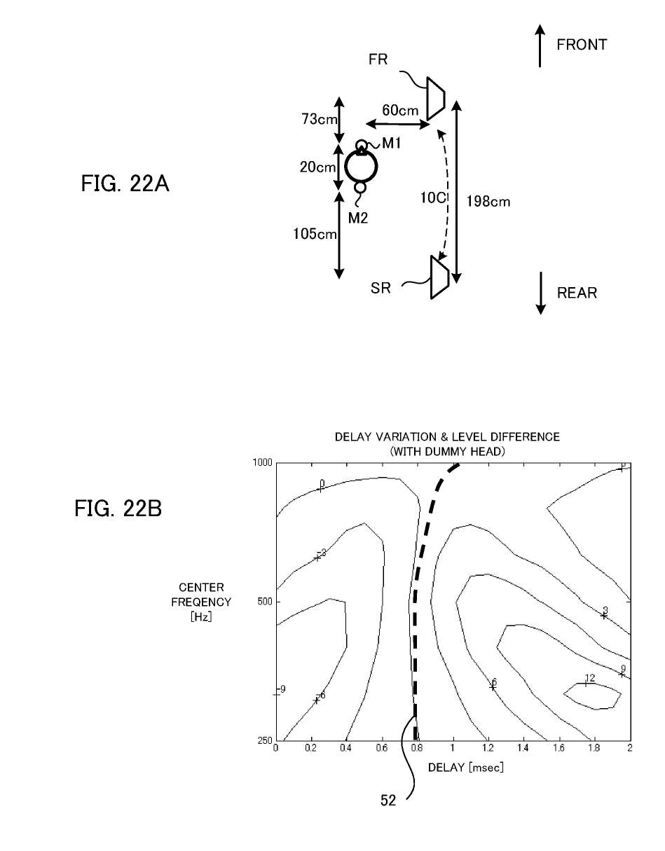

FIG. 22 shows the distribution of the level difference when the delay amounts for the respective frequency bands are varied, in the case where the vertical distance from the speaker pair 10C and the listener position is 60 cm. The broken line 52 in FIG. 22 shows the graph on which the level difference of the microphones M1 and M2 becomes zero. In this case, the optimum delay amount with which the level difference becomes zero is about 0.8 msec up to the frequency 500 Hz, but the optimum delay amount increases if the frequency exceeds the frequency 500 Hz. However, the increasing amount is smaller than that in the case where the vertical distance is 40 cm.

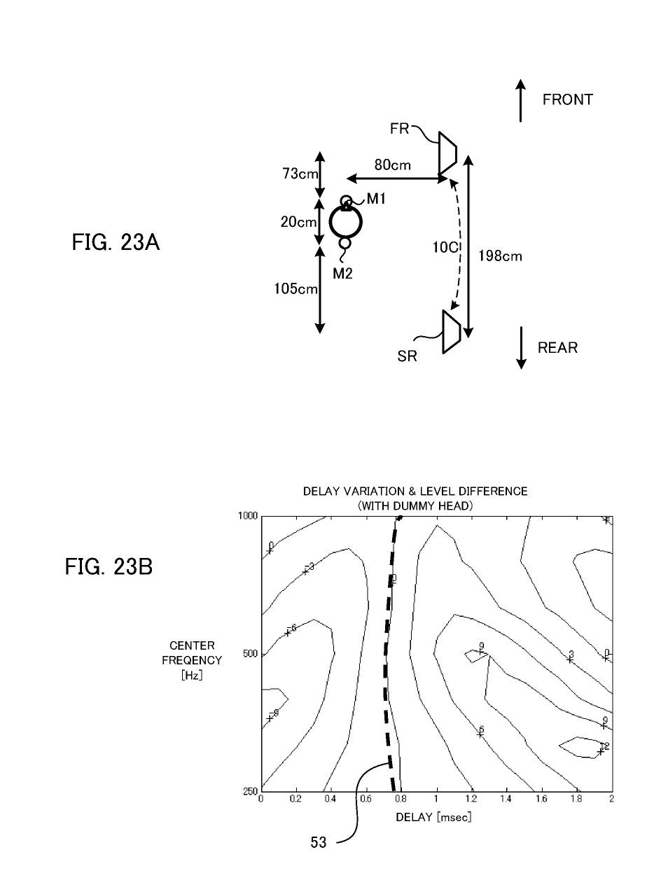

FIG. 23 shows the distribution of the level difference when the delay amounts for the respective frequency bands are varied, in the case where the vertical distance from the speaker pair 10C and the listener position is 80 cm. The broken line 53 in FIG. 23 shows the graph on which the level difference of the microphones M1 and M2 becomes zero. In this case, the optimum delay amount with which the level difference becomes zero is about 0.8 msec, regardless of the frequency band.

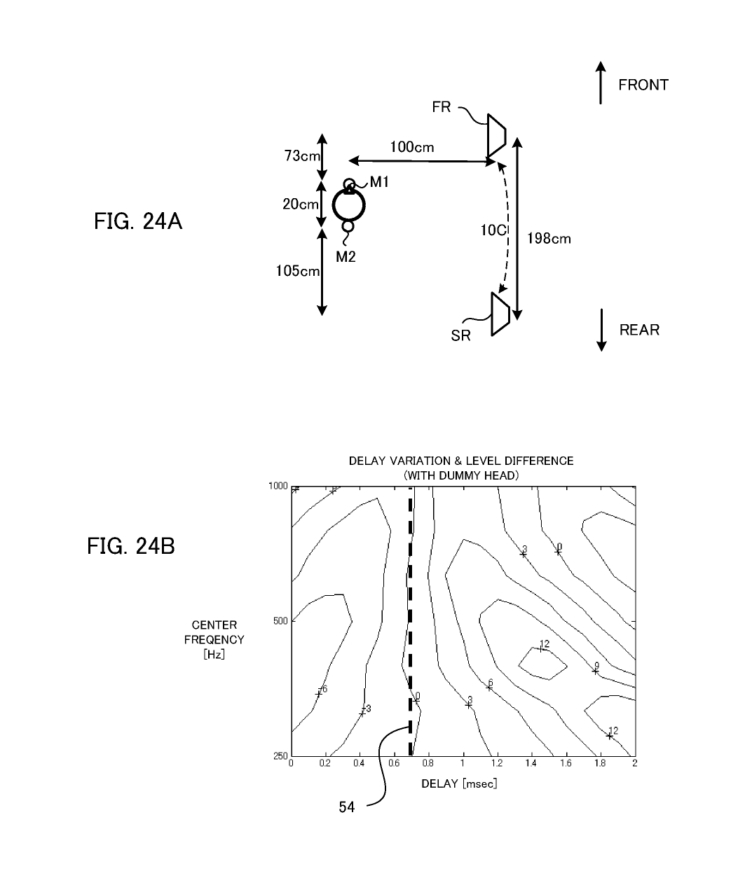

FIG. 24 shows the distribution of the level difference when the delay amounts for the respective frequency bands are varied, in the case where the vertical distance from the speaker pair 10C and the listener position is 100 cm. The broken line 54 in FIG. 24 shows the graph on which the level difference of the microphones M1 and M2 becomes zero. In this case, the optimum delay amount with which the level difference becomes zero is about 0.7 msec, regardless of the frequency band.

As is understood from FIGS. 21 to 24, as the vertical distance between the speaker pair 10C and the listener position becomes longer, the influence by the head of the driver at the listener position becomes weaker, and the optimum delay amount tends to be a constant value in each frequency band. Namely, if the position of the speaker pair is moved apart from the listening position, the optimum delay amount with which the level difference of the speaker pair becomes zero varies according to the frequency until the distance between the speaker pair and the listening position reaches a certain distance, but becomes constant if the distance exceeds the certain distance. While it depends on the size of the vehicle to which the present invention is applied, the vertical distance between the listener position and the proximity speaker pair is usually equal to or smaller than 50 cm in a vehicle of a general size. Therefore, it is understood that it is effective to give the delays of the different delay amounts for the respective frequency bands at least to the proximity speaker pair and to give a delay of a constant delay amount to the speaker pair having a long vertical distance to the listener position regardless of the frequency band, like the sound field adjusting device according to the present invention. Namely, assuming that the distance with which the optimum delay amount making the level difference of the speaker pair zero varies according to the frequency is “predetermined distance”, the present invention is effective for the speaker arrangement in which the distance between the listening position and at least one speaker pair is equal to or smaller than the above-mentioned predetermined distance.

### Effect of the Invention

As described above, the sound field adjusting device which reproduces the signals from the plural speaker pairs arranged in the acoustic space includes a signal supplying unit which supplies the signals to the plural speakers, a frequency band dependent delay unit which gives delays of delay amounts different for respective frequency bands to the signals supplied to at least a proximity speaker pair, which is a speaker pair nearest from the listening position, and a constant delay unit which gives delays of a constant delay amount to the speaker pairs, other than the speaker pairs to which the frequency band dependent delay unit gives the delays, regardless of the frequency bands.

In this case, since the sound field adjusting device performs the sound field adjustment, not by adjusting the levels, but only by adjusting the delay amounts, it can be prevented that the sound pressure balance is deteriorated at the positions other than the listening position, as a result of the adjustment of the sound pressure balance at the listening position, and further the sound pressure balance can be improved at the listening position.

Generally, if the influence by the head is neglected, the sound pressure balance can be adjusted by giving a constant delay amount regardless of the frequency and positioning the high sound pressure range (the peak stripes 25 in this embodiment) near the listening position. However, if the head of the listener exists at the listening position, the levels in front and behind the listening position is disturbed due to the influence by the head. It is said that the influence by the head is larger as the frequency is higher and larger as the distance from the listening position is shorter.

Therefore, the sound field adjusting device according to the present invention gives the different delay amounts for the respective frequency bands to the signals supplied to the proximity speaker pair. In this way, since the sound field adjusting device gives the delay of the different delay amounts for the respective frequency bands to the speaker pairs susceptible to the influence by the head of the listening position, it becomes possible to avoid the deterioration of the sound pressure balance in front and behind the listening position and the position near the listening position.

Further, the sound field adjusting device determines the delay amounts such that the level difference of the speaker pairs 10A to 10C becomes zero. Thus, the sound field adjusting device can diminish the level difference in the front-rear direction and in the left-right direction of the listening position.

### MODIFICATIONS

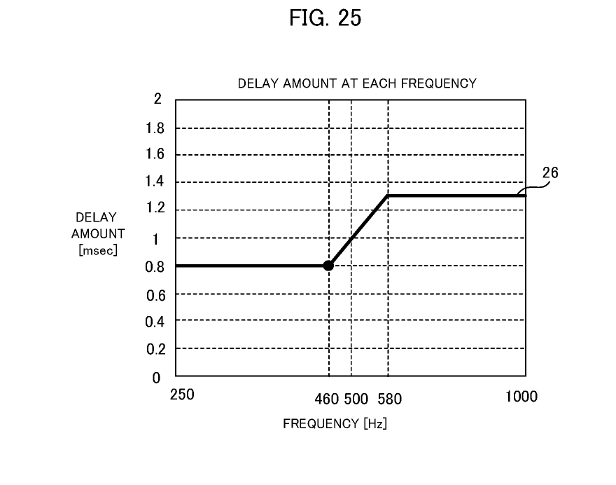

The above-described embodiments are directed to the case where the delay amounts of the proximity speaker pair is determined based on the measurement result of the microphones M1 to M4, but the present invention is not limited to this. The reference frequency may be calculated based on the distance from the listener position to the speakers, and the delay amounts may be set stepwise from the reference frequency to a frequency of a predetermined range for the amount of the increase of the frequency. FIG. 25 shows the graph 26 of the delay amounts based on the calculated reference frequency. In the case of the graph 26, the reference frequency is 460 Hz, and the delay amount is increased in the frequency range 460 Hz to 580 Hz.

In this case, unlike the above embodiments, the burden on the measurement process can be reduced, and the sound field adjusting device can determine the delay amounts in accordance with the influence by the head at the listening position.

In the above embodiment, the sound field adjusting device does not delay the signals supplied to the speaker pair 10D. However, the present invention is not limited to this, and a constant delay can be given to the signals supplied to the speaker pair 10D.

The above embodiments are directed to the case where the sound field adjusting device determines one proximity speaker pair. However, the present invention is not limited to this, and plural speaker pairs of substantially same distance may be determined as the proximity speaker pairs.

The above embodiments are directed to the case where the delay amounts are determined such that the level difference of the speaker pair 10C, which is the proximity speaker pair, becomes zero. However, the present invention is not limited to this, and the level difference may be determined to be smaller than a predetermined value (e.g., 3 dB). Also in this case, the sound field adjusting device can reduce the level difference in the front-rear direction and the left-right direction at the driver's seat and the assistant driver's seat.

### INDUSTRIAL APPLICABILITY

This invention can be used in a device for adjusting a sound field.

### DESCRIPTION OF REFERENCE NUMBERS

5 Signal Processing Unit

6 Mixer

8 Band Dividing Unit

9 Delay Unit

10 Speaker Pair

1. A sound field adjusting device which is arranged in an acoustic space and which reproduces signals from plural speakers arranged within a predetermined distance from a listening position, the predetermined distance being a distance at which an optimum delay amount making the level difference of the speaker pair zero varies dependently upon the frequency, the device comprising:
a signal supplying unit which supplies the signals to the plural speakers;
a frequency band dependent delay unit which gives delays of delay amounts different for respective frequency bands to the signals supplied to at least a proximity speaker pair, which is a speaker pair nearest from the listening position; and
a constant delay unit which gives delays of a constant delay amount to the speaker pairs, other than the speaker pairs to which the frequency band dependent delay unit gives the delays, regardless of the frequency bands.

2. The sound field adjusting device according to claim 1,
wherein the speaker pairs are arranged in one of a front-rear direction and a left-right direction of the listening position, and
wherein the frequency band dependent delay unit determines the delay amounts such that a level difference of the proximity speaker pair becomes equal to or smaller than a predetermined value.

3. The sound field adjusting device according to claim 1, wherein the speaker pairs are arranged in one of a front-rear direction and a left-right direction of the listening position,
wherein the frequency band dependent delay unit determines the delay amounts such that a level difference of the proximity speaker pair becomes zero, and
wherein the constant delay unit determines the delay amount such that the level difference of the speaker pairs other than the proximity speaker pair becomes zero.

4. The sound field adjusting device according to claim 1, wherein the frequency band dependent delay unit makes the delay amounts given to the signal of high frequency larger than the delay amounts given to the signal of low frequency.

5. The sound field adjusting device according to claim 4, wherein the frequency band dependent delay unit gradually increases the delay amounts as the frequency increases, for the signal belonging to a predetermined frequency range equal to or higher than a reference frequency.

6. The sound field adjusting device according to claim 1, wherein the frequency band dependent delay unit and the constant delay unit eliminate the speaker pair farthest from the listening position from the speaker pairs subjected to a process of determining the delay amount.

7. The sound field adjusting device according to claim 1,
wherein the proximity speaker pair is one of the speaker pairs whose vertical distance from the listening position is shortest, and
wherein the vertical distance indicates a shortest distance from a straight line connecting the two speakers constituting the speaker pair to the listening position.

8. (canceled)

9. The sound field adjusting device according to claim 1, wherein a center frequency of the frequency band is 25 Hz to 1 kHz.
